(19) United States
(12) Patent Application Publication
(10) Pub. No.: US 2002/0124804 A1
(43) Pub. Date: Sep. 12, 2002

(54) Feeding apparatus, intended in particular for supplying concentrate

(75) Inventors: Renatus Ignatius Josephus Fransen, Vlaardingen (NL); Albert Freddie Kamps, Maassluis (NL)

Correspondence Address: Penrose Lucas Albright, Esq., MASON, MASON & ALBRIGHT, P.O. Box 2246, Arlington, VA, 22202-0246, US

(73) Assignee: MAASLAND N.V. a Dutch limited liability company

(21) Appl. No.: 09/818,893

(22) Filed: Mar. 28, 2001

Related U.S. Application Data
(63) Continuation of application No. PCT/NL00/00444, filed on Jun. 23, 2000.

(30) Foreign Application Priority Data
Jul. 29, 1999 (NL) 1012739

(51) Int. Cl. A01K 61/02

(52) U.S. Cl. 119/52.1

(57) ABSTRACT

An apparatus for automatically milking animals, such as cows, wherein the milking parlor contains a feeding apparatus for providing, in particular, concentrate. The apparatus has at least one hopper for storing the feed and at least one metering unit for metering the feed from the hopper into at least one conveyor channel. From the conveyor channel, the feed is received by a manger. The feeding apparatus comprises several embodiments of cleaning devices for preventing the conveyor channel from collecting undesired substances that may contaminate or clog the channel or cause both problems. The cleaning device may be an air blower which blows air through perforations in the wall of the conveyor channel towards the manger, the perforations being in the form of lamellae. Also an air blower may move air through a channel which debouches proximate the manger. Restrictions may be provided in the conveyor channel to prevent undesired substances such as exhalations of animals feeding at the manger from moving upwardly through the conveyor channel. Brushes or wipers to clean the conveyor channel may also be provided. Still further, drivable supply members such as brushes, augers or cam wheels may be provided. In addition, the apparatus may include detection means which detects and provide a signal when the conveyor channel is clogged or otherwise contaminated.

### RELATED APPLICATION

This is a Continuation of International Application PCT/NL00/00444, filed Jun. 23, 2000.

### FIELD OF INVENTION

The invention relates to a feeding apparatus intended in particular for supplying concentrates, which apparatus includes a hopper for storing the feed, a metering unit for metering the feed, and a conveyor channel for delivering feed from the hopper to a manger.

### BACKGROUND OF THE INVENTION

In known feeding apparatus of this type, problems arise in the conveyor channel, especially when the outlet of the conveyor channel is situated above the manger. The problems result from the fact that the air exhaled by the animal during eating penetrates into the conveyor channel and condenses against the wall thereof, so that some of the concentrate cakes on the wall of the conveyor channel, which may lead to clogging or an unfavorable discharge of the feed via the conveyor channel.

### SUMMARY OF THE INVENTION

An apparatus of the invention is to provide feeding apparatus in which the above-mentioned drawback is obviated or at least minimized.

In accordance with the invention, this is achieved by providing preventive or cleaning means to preclude or eliminate contamination or clogging or both in the conveyor channels.

According to the first embodiment of the invention, the preventive means comprises de-aerating means with the aid of which the conveyor channel is de-aerated. The de-aerating means ensures that the exhaled air that penetrates into the conveyor channel is immediately removed, so that it is prevented from condensing against the wall of the conveyor channel. According to an inventive feature, the de-aerating means comprises at least one perforation in the conveyor channel. Because a large aperture in the conveyor channel may result in spillage of feed beyond the conveyor channel, according to an inventive feature it is also possible to provide various small perforations in the conveyor channel. Thus, there is created a grid-like perforation pattern. In order to avoid, also in this situation, spillage of feed beyond the conveyor channel, according to a further inventive feature, the perforations are designed as lamellae which extend towards the inside of the conveyor channel. For the purpose of removing the exhaled air as quickly as possible, according to a further inventive feature, the preventive or de-aerating means of both are disposed at least near the lower side of the conveyor channel. In the case that various hoppers are disposed above the conveyor channel, the conveyor channel will usually be relatively wide. In order to avoid that the exhaled air rises in the conveyor channel, there is provided a constriction in the conveyor channel. According to an inventive feature, the constriction is situated near the lower side of the conveyor channel, and the de-aerating means is disposed below the constriction. According to an inventive feature, the constriction is constituted by a V-shaped portion.

In accordance with the second embodiment of the invention, the de-aerating means comprises a breather duct which debouches into the conveyor channel. Therefore, the invention also relates to a feeding apparatus, in particular for supplying concentrates, which is provided with at least one hopper for storing the feed and with one metering unit for metering the feed, as well as with at least one conveyor channel, via which the feed flows from the hopper into a manger, characterized in that the feeding apparatus comprises de-aerating means in the form of a breather duct which debouches into the conveyor channel.

By means of the breather duct, like with a flue or chimney, it is possible to create an air flow in the conveyor channel, so that the exhaled air is removed. According to a further inventive feature, the lower end of the breather duct debouches near the place where the feed passes into the manger. According to another inventive feature, it is also possible forcibly to remove the air exhaled by the animal. To that end, according to an inventive feature, the de-aerating means comprises air blowing means with the aid of which an air flow is forcibly created in the conveyor channel or the breather duct or the manger or any combination thereof. In a simple embodiment of the invention, the air blower means comprises a ventilator. In order to save energy, according to an inventive feature, the air blower means is automatically activated when the detection means detect that an animal is in the vicinity of the feeding apparatus.

In accordance with another embodiment of the invention, the preventive means comprises automatic supply means which is disposed near the lower end of the conveyor channel and, in the situation of proportional metering, opens the conveyor channel just before metering or during metering the feed and subsequently closes same, or, in the situation of continuous metering, opens the conveyor channel in such a manner that the feed flows exactly through the released opening. In the former case, such time when metering is actuated temporarily, the valve is opened and closed quickly by the operating means, such that the channel is only opened for discharging the feed. In the latter case, the valve is opened or closed to a larger extent, depending on the amount of feed which is introduced into the conveyor channel per unit of time by the metering unit. Thus, the metered feed closes the opening of the conveyor channel so that the exhaled air is prevented from penetrating into the conveyor channel. According to a further inventive feature, the automatic supply means comprises a non-return valve or a freely rotatable cam wheel. According to another inventive feature, the non-return value is controlled by means of a spring under preferably adjustable spring action. According to again another inventive feature, the supply means may also comprise a drivable supply member. According to the invention, said supply member may comprise a brush or an auger or a cam wheel.

In accordance with another embodiment of the invention, the preventive means, in particular the cleaning means, comprises a sweeping device by means of which the wall of the conveyor channel is swept. Then, the sweeping device is arranged in the conveyor channel in such a manner that condensation or feed or both remaining therein is swept by the sweeping device from the conveyor channel to the manger. In an embodiment of the invention, the sweeping device comprises at least one drivable wiper device by means at least part of the wall of the conveyor channel is cleaned. In again another embodiment of the invention, the sweeping device comprises a brush which is drivable or movable or both along the wall of the conveyor channel.

According to another inventive feature, the feeding apparatus, in particular the conveyor channel, is provided with detection means which provides a signal when the conveyor channel is contaminated or clogged or both. The signal may serve as a control signal for the cleaning means or as a warning signal for a supervisor or may serve both purposes.

The invention also relates to an apparatus for automatically milking animals, such as cows, provided with a milking parlor with a milking installation and a feeding apparatus as described above. According to a further inventive feature, the apparatus comprises a milking robot by means of which teat cups are automatically connected to the teats of an animal to be milked.

### BRIEF DESCRIPTION OF THE DRAWINGS

The invention will now be explained in further detail with reference to the accompanying drawings.

FIG. 1 is a cross-sectional side elevational view of a first embodiment of a feeding apparatus according to the invention;

FIG. 2 is a view similar to FIG. 1 of a second embodiment of a feeding apparatus according to the invention;

FIG. 3 is a view similar to FIG. 1 of a third embodiment of a feeding apparatus according to the invention;

FIG. 4 is a view similar to FIG. 1 of a fourth embodiment of a feeding apparatus according to the invention;

FIG. 5 is a view similar to FIG. 1 of a fifth embodiment of a feeding apparatus according to the invention; and

FIG. 6 is a view similar to FIG. 1 of a sixth embodiment of a feeding apparatus according to the invention.

### BRIEF DESCRIPTION OF THE PREFERRED EMBODIMENTS

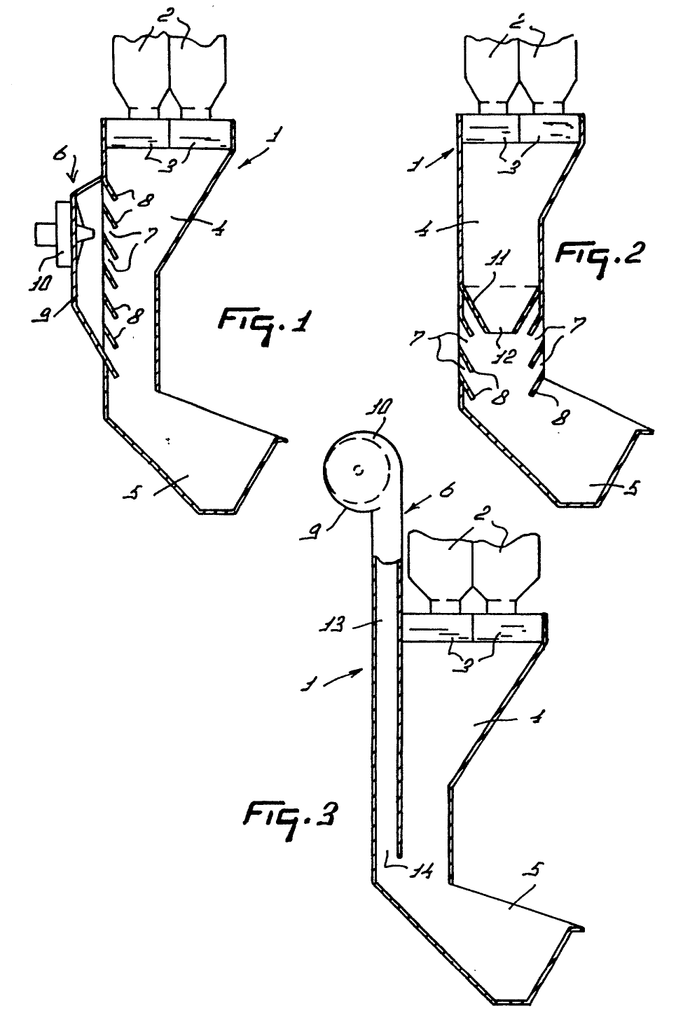

FIG. 1 is a cross-sectional view of a feeding apparatus 1 which, in the present embodiment, is designed as a apparatus for supplying concentrate. Feeding apparatus 1 comprises two hoppers 2 in which two different types of concentrate can be stored. Near the lower end of each hopper 2 a respective metering unit 3 is provided by means of which continuously or periodically concentrate can be caused to flow from the hopper into a conveyor channel 4. The outlet of conveyor channel 4 is situated above a manger 5. In an exterior wall of conveyor channel 4 a de-aerating means 6 is disposed. De-aerating means 6 comprises perforations 7, each of which is covered by a lamella 8. Perforations 7 may have any desired shape and may, thus for example, be constituted by a round or a slotted hole. For the purpose of removing the air exhaled by an animal still more efficiently, in the present embodiment de-aerating means 6 comprises air blower means 9. Air blower means 9 is constituted by a fan or ventilator 10. It is also possible to construct de-aerating means 6 without air blower means 9.

FIG. 2 shows a second embodiment of a feeding apparatus 1 according to the invention, in which parts corresponding to those of the first embodiment are indicated by the same reference numerals. In the second embodiment of the invention, conveyor channel 6 is narrowed because of having near its lower side a V-shaped portion 11. The opening 12 near the lower side of the V-shaped portion 11 of the conveyor channel 4 is sufficient to discharge the maximum amount metered by metering unit 3. As shown in FIG. 2, perforations 7 are provided below the V-shaped portion 11 of conveyor channel. Thus very little air exhaled by the animal if any, reaches the upper part of conveyor channel 4, but only in the lower part thereof where it is immediately removed via the perforations, and that part of the conveyor channel 4 (which contains perforations 7) does not come into contact with the metered concentrate.

FIG. 3 shows a third embodiment of a feeding apparatus 1 according to the invention, in which parts corresponding to those of the previous embodiments are indicated by the same reference numerals. In the third embodiment of the invention, de-aerating means 6 comprises a breather duct 13, the lower end 14 of which debouches near the lower side of conveyor channel 4. Breather duct 13 is also provided with air blower means 9 which comprise a fan or ventilator 10. However, it is also possible to remove air exhaled by the animal by means of the breather duct 13 without using said air blower means.

FIG. 4 shows a fourth embodiment of a feeding apparatus 1 according to the invention, in which parts corresponding to those of the previous embodiments are indicated by the same reference numerals. In this fourth embodiment of the invention, near the lower side of conveyor channel 4, an automatic supply means 15 is disposed which opens conveyor channel 4 proportionally, only when feed is caused to flow into conveyor channel 4. In the present embodiment, automatic supply means 15 comprises a non-return valve 16 which is capable of moving downwardly against spring action thus allowing the metered concentrate to fall into manger.

FIG. 5 shows a fifth embodiment of a feeding apparatus 1 according to the invention, in which parts corresponding to those of the previous embodiments are indicated by the same reference numerals. In the fifth embodiment of the invention, automatic supply means 15 comprises a motor-drivable supply member 17. In the present embodiment, drivable supply member 17 is constituted by a brush 18. However, instead of a brush 18 an auger or a cam wheel may be substituted. If a cam wheel is substituted it is also possible to provide a freely rotatable cam wheel. When metering units 3 are actuated, drivable supply member 17 is actuated as well.

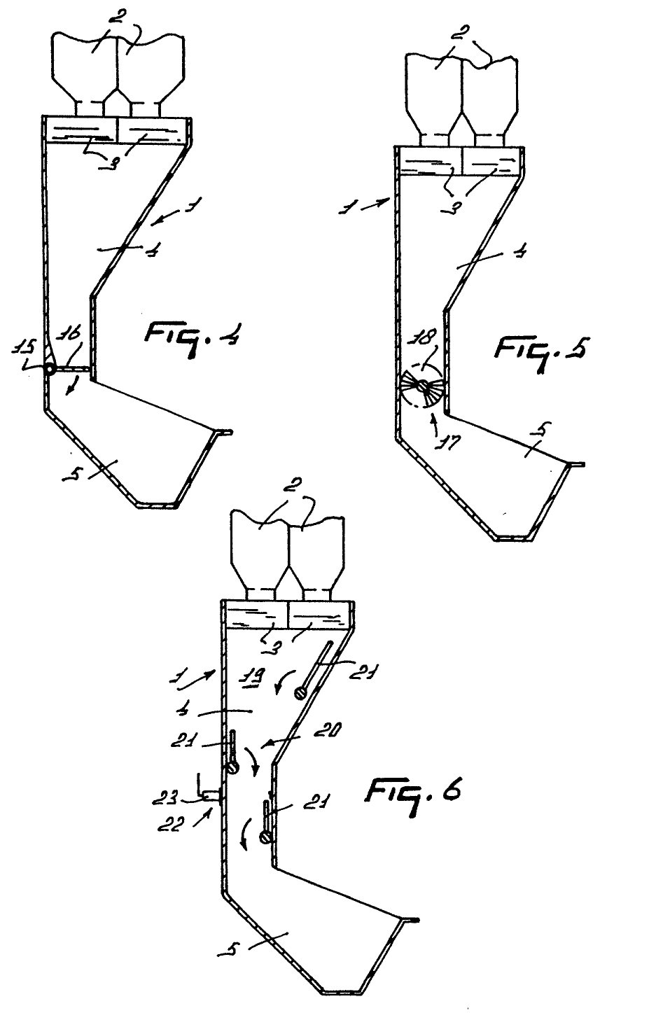

FIG. 6 shows a sixth embodiment of a feeding apparatus 1 according to the invention, in which parts corresponding to those of the previous embodiments are indicated by the same reference numerals. In the sixth embodiment of the invention feeding apparatus 1 comprises cleaning means 19 with the aid of which conveyor channel 4 is cleaned. In the present embodiment, cleaning means 19 comprises a sweeping device 20. Sweeping device 20 comprises a plurality of motor-driven wipers 21 which are disposed against the walls of conveyor channel 4. Wipers 21 are arranged in such a manner that condensation or dirt or both are conveyed from conveyor channel 4 by wipers 21 to manger 5.

The sixth embodiment of the invention also includes detection means 22 which provides a signal when the walls of conveyor channel 4 are contaminated or conveyor channel 4 is clogged or both conditions exist. Detection means 22 comprises a sensor 23 which is disposed in conveyor channel 4 and by means of which the wall of conveyor channel 4 can be examined. Sensor 23 may be an optic or an acoustical or even a mechanical sensor. Detection means 22 as well as cleaning means 19 may also be used in the other embodiments.

Although we have disclosed the preferred embodiments of our invention, it is to be understood that it is capable of other adaptations and modifications within the scope of the following claims:

1. A feeding apparatus (1), intended in particular for supplying concentrate, provided with at least one hopper (2) for storing the feed and at least one metering unit (3) for metering the feed, as well as at least one conveyor channel (4) via which the feed from the hopper (2) is poured into a manger (5), characterized in that the feeding apparatus (1) comprises preventive and/or cleaning means (6; 15; 19) with the aid of which the conveyor channel (4) is at least prevented from being contaminated and/or clogged.

2. A feeding apparatus as claimed in claim 1, characterized in that the preventive means comprise de-aerating means (6) with the aid of which the conveyor channel (4) is de-aerated.

3. A feeding apparatus as claimed in claim 2, characterized in that the de-aerating means (6) are constituted by at least one perforation (7) in the conveyor channel (4).

4. A feeding apparatus as claimed in claim 3, characterized in that various perforations (7) are provided in the conveyor channel (4).

5. A feeding apparatus as claimed in claim 3 or 4, characterized in that the perforations (7) are designed as lamellas (8) which extend towards the inside of the conveyor channel (4).

6. A feeding apparatus as claimed in any one of the preceding claims, characterized in that the preventive and/or de-aerating means are disposed at least near the lower side of the conveyor channel (4).

7. A feeding apparatus as claimed in any one of the preceding claims, characterized in that there is provided a constriction (11) in the conveyor channel (4).

8. A feeding apparatus as claimed in claim 7, characterized in that the constriction (11) is provided above the de-aerating means (6).

9. A feeding apparatus as claimed in claim 7 or 8, characterized in that the constriction (11) is constituted by a V-shaped portion.

10. A feeding apparatus as claimed in any one of the preceding claims, characterized in that the de-aerating means (6) comprise a breather duct (13) which debouches into the conveyor channel (4).

11. A feeding apparatus as claimed in claim 6, characterized in that the lower end of the breather duct (13) debouches near the place where the feed is poured into the manger (5).

12. A feeding apparatus as claimed in any one of the preceding claims, characterized in that the de-aerating means (6) comprise air forcing means (9) with the aid of which an air flow is forcibly created in the conveyor channel (4) and/or the breather duct (13) and/or the manger (5).

13. A feeding apparatus as claimed in claim 12, characterized in that the air forcing means (9) comprise a ventilator (10).

14. A feeding apparatus as claimed in claim 12 or 13, characterized in that the air forcing means (9) are automatically activated when there is detected with the aid of detection means that an animal is located in the vicinity of the feeding apparatus (1).

15. A feeding apparatus as claimed in any one of the preceding claims, characterized in that the preventive means comprise automatic supply means (15) which are disposed near the lower end of the conveyor channel (4) and, in the situation of proportional metering, release the conveyor channel (4) just before metering or during metering of the feed and subsequently close same, or, in the situation of a continuous metering, release the conveyor channel (4) in such a manner that the feed flows exactly through the released opening.

16. A feeding apparatus as claimed in claim 15, characterized in that the automatic supply means (15) comprise a non-return valve (16) or a freely rotatable cam wheel.

17. A feeding apparatus as claimed in claim 16, characterized in that the non-return valve (16) is controlled by means of a spring under preferably adjustable spring action.

18. A feeding apparatus as claimed in any one of claims 15 to 17, characterized in that the automatic supply means (15) comprise a drivable supply member (17).

19. A feeding apparatus as claimed in claim 18, characterized in that the drivable supply member (17) comprises a brush (18) or an auger or a cam wheel.

20. A feeding apparatus as claimed in any one of the preceding claims, characterized in that the preventive means and in particular the cleaning means (19) comprise a sweeping device (20) by means of which the wall of the conveyor channel (4) is swept.

21. A feeding apparatus as claimed in claim 20, characterized in that the sweeping device (20) comprises at least one drivable wiper device (20, 21) by means of which at least part of the wall of the conveyor channel (4) is cleaned.

22. A feeding apparatus as claimed in claim 20 or 21, characterized in that the sweeping device (20) comprises a brush which is drivable and/or movable along the wall of the conveyor channel.

23. A feeding apparatus as claimed in any one of the preceding claims, characterized in that the feeding apparatus (1) is provided with detection means (22) which supply a signal when the conveyor channel (4) is contaminated and/or clogged.

24. An implement for automatically milking animals, such as cows, comprising a milking parlour with a milking installation and a feeding apparatus as described in any one of claims 1 to 23.

25. An implement as claimed in claim 24, characterized in that the implement comprises a milking robot.
